(19) United States
(12) Patent Application Publication
(10) Pub. No.: US 2012/0245847 A1
(43) Pub. Date: Sep. 27, 2012

(54) System and Method for Agenda Management

(75) Inventors: Ping Cheng, (US); Yu Lin, Beijing (CN); Shihong Zou, Beijing (CN)

(73) Assignee: Beijing NetQin Technology Co. LTD., Dongcheng District, Beijing (CN)

(21) Appl. No.: 13/412,190

(22) Filed: Mar. 5, 2012

(30) Foreign Application Priority Data
Mar. 4, 2011 (CN) 201110053139.9

(51) Int. Cl. G01C 21/20; G06F 21/00

(52) U.S. Cl. 701/527; 726/26; 701/532; 701/533

(57) ABSTRACT

The present disclosure relates to method and system for agenda management. A method for agenda management includes creating an agenda event and details of the agenda event by an initiator, configuring privacy attributes for the agenda event, and viewing by a receiver the details of the agenda event and a list of all participants of the event based on the privacy attributes. The method for agenda management further includes creating or editing agenda through web pages and sending the agenda or the updates of the agenda to participants as a file or a message. Participants may also view, download and/or forward the agenda through web pages. With privacy attributes, it could be easier for a user to search the agenda, sharing agendas having tertian privacy attributes with others, which balances the efficiency and privacy. In addition, the attributes can be manually amended by users.

### FIELD OF THE INVENTION

The present invention generally relates to software application for mobile communication and computer and, more particularly, to system and method for agenda management.

### BACKGROUND

Existing techniques for managing agenda events relies on a very simple functionality of recording. Those existing techniques are not intelligent and do not meet the requirements in real life or business scenarios. In real life, some detailed aspects of agenda management need attention to provide better solution, such as, how to properly share agenda events, how to timely remind users about the events, and how to inform participants any update of the agenda event, etc.

### SUMMARY

In view of the foregoing disadvantage of the existing technique, the present disclosure provides a method for managing agenda events that can configure privacy attributes for the agenda event, thus facilitating agenda event searching and protecting privacy when sharing the agenda. According to one aspect, the method for managing agenda event also provides an approach for creating and sharing agenda through network, which is more economic and convenient. For agenda events, the method in the present disclosure can schedule alerts, according to the information, such as, event's city name, time, location and content, etc. Thus, the functionality of agenda alerts is improved. Moreover, after sending the alert to the user, the method in the present disclosure can further monitor the location of the user and the traffic on the route to the event, make estimation about whether the user could attend the event in time, and if the user would be late for the event. The method in the present disclosure can also include notifying the initiator about the delay and an estimated arrival time. Thus, the risk of messaging or calling during driving can be avoided.

In general, in one aspect, a method for managing agenda events includes creating an agenda event and details of the agenda event by an initiator, configuring privacy attributes for the agenda event, and viewing by a receiver the details of the agenda event and a list of all participants of the event based on the privacy attributes.

Implementations of the method may provide one or more of the following features. The privacy attributes are configured to allow accessibility for receivers only or accessibility for everybody, wherein accessibility for receivers only allows the details of the agenda event to be viewable among receivers who accept the agenda event, and wherein accessibility for everybody allows the details of the agenda event to be viewable to everyone on the Internet. The method further includes creating or editing the agenda event on a web page, and sending the agenda event or updates of the agenda event as a file or a message to participants, wherein the participants can view, download and/or forward the agenda event. The method further includes acquiring location and schedule information of the agenda event, and computing corresponding reminding time according to the location and schedule information of the agenda event.

In general, in another aspect, a method for managing agenda events includes monitoring and controlling a local time, until a predetermined reminding time, acquiring a current location information of a user and, if it fails, sending an alert immediately, if it succeeds, planning a route to a location of an event according to the current location information, acquiring a length of the route and acquiring an average vehicle speed on the route during a period at the beginning of the event, computing time consumed, computing an actual alert time, and sending the alert if the local time is equal to or later than the actual alert time.

Implementations of the method may provide one or more of the following features. The method further includes detecting the current location of the user periodically after sending the alert, and determining whether the user is on the way to the event, according to the current location of the user, and if not, sending the alert again. The method further includes detecting the current location of the user, if the user has set off, planning the route to the location of the event according to the current location of the user, if the user has not arrived, acquiring a remaining length of the route and an average vehicle speed on the route during a period at the beginning of the event, computing a remaining time for the route, and computing an arrival time and, if the arrival time is later then the start time of the event, informing participants or initiator of a delay or a estimated arrival time.

In general, in yet another aspect, a system for managing agenda events includes a client side module, a server, and a network side module, wherein the client side module includes: an agenda event alerting module for sending alerts for agenda events, a location and map information loading module for loading location and map information, a communication module for synchronizing agenda information between the client side module and the network side module, an agenda information management and storage module for managing and storing agenda information and sending information corresponding to the alert to the agenda event alerting module, wherein the server includes: an agenda information database for storing and maintaining and a communication module for synchronizing agenda information between the client side module and the network side, wherein the network side module includes: an agenda event editing and managing module for editing and managing agenda events and a communication module for synchronizing agenda information between the server and the network side module.

Implementations of the system may provide one or more of the following features. The agenda information management and storage module is configured to acquire location and map information from the location and map information loading module, compute a route based on the location and map information, and determine an alert time according to the stored agenda event information or determine whether to send a notice for late arrival. The network side module includes a web page via which a user creates and manages the agenda events.

The methods and systems for managing agenda events in the embodiments present prominent progress. It is very convenient to create, edit, send, and share agenda through network. The methods and systems for managing agenda events according to the embodiments allow for configuring privacy attributes for agenda events, making it easier to search and find an event and solving the conflict between sharing and privacy protection, saving the cost of users for managing agenda events. The methods and systems for managing agenda events according to the embodiments may compute an alert schedule according to the content, time and location of the event, greatly improving the convenience. The method for managing agenda events according to the embodiments may monitor the location of the user, determine whether the user would be late for the event, and if a delay estimated, notify the participants or the initiator of the event, thus improving interaction and avoiding the risk of messaging or calling when driving.

The afore-mentioned characteristics and advantages will be more apparent in view of the following drawing and detailed description that are incorporated herewith. The drawings and the detailed description are presented to specify the principle and do not limit the scope of the invention.

### BRIEF DESCRIPTION OF THE DRAWINGS

FIG. 1 is a schematic illustration of a system for managing agenda events according to an embodiment of the invention;

FIG. 2 is a flow diagram describing a process for automatically configuring attributes of agenda events according to an embodiment of the invention;

FIG. 3 is a flow diagram describing a process for creating and managing agenda events through network according to an embodiment of the invention;

FIG. 4 is a flow diagram describing a process for determining alert schedule according to an embodiment of the invention;

FIG. 5 is a flow diagram describing a process for computing actual alert time and sending alerts according to an embodiment of the invention;

FIG. 6 is a flow diagram describing a process for computing actual alert time and sending alerts according to another embodiment of the invention;

FIG. 7 is a flow diagram describing a process for monitoring a route and notifying a delay an embodiment of the invention.

### DETAILED DESCRIPTION

The embodiments are described hereinafter with reference to the accompanying drawings of the present disclosure. In the description below, a large amount of details are described for better understanding. However, those skills in the art should know that the present invention is not limited to these details.

The disclosure provides a method for managing agenda events that can configure privacy attributes for the agenda events, thus facilitating agenda event searching and protecting privacy when sharing the agenda. According to one aspect, the method for managing agenda events also provides an approach for creating and sharing agenda through network, which is more economic and convenient. For agenda events, the method of the present disclosure can schedule alerts, according to the information, such as, event's city name, time, location and content, etc, improving the functionality of agenda alerts. Moreover, after sending the alert to the user, the method of the present disclosure can further monitor the location of the user and the traffic on the route to the event, making estimation about whether the user could attend the event in time, and if the user would be late for the event, the method of the present disclosure also includes notifying the initiator about the delay and an estimated arrival time, avoiding the risk of messaging or calling during driving. The embodiments are described hereinafter with reference.

According to one embodiment, a system for managing agenda events includes a client side module, a server, and a network side. The client side module includes an agenda event alerting module for sending alerts for agenda events, a location and map information loading module for loading location and map information, a communication module for synchronizing agenda information between the client side module and the network side, and an agenda information management and storage module for managing and storing agenda information and sending information corresponding to the alert to the agenda event alerting module. The server includes an agenda information database for storing and maintaining and a communication module for synchronizing agenda information between the client side module and the network side. The network side includes an agenda event editing and managing module for editing and managing agenda events and a communication module for synchronizing agenda information between the server and the network side.

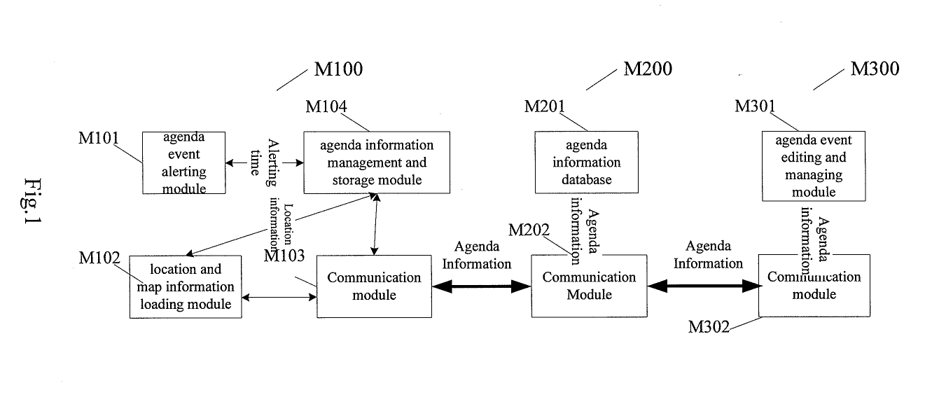

FIG. 1 is a schematic illustration of a system for managing agenda events according to an embodiment of the invention. In FIG. 1, the system for managing agenda events can include a client side module M100, a server M200 and a network side module M300.

The client side module M100 can include an agenda event alerting module M101 for sending alerts for agenda events, a location and map information loading module M102 for loading location and map information, a communication module M103 for synchronizing agenda information between the client side module M100 and the server M200, an agenda information management and storage module M104 for managing and storing agenda information and sending information corresponding to the alert to the agenda event alerting module M101.

The server M200 can include an agenda information database M201 for storing and maintaining and a communication module M202 for synchronizing agenda information between the client side module M100 and the network side module M300.

The network side module M300 can include an agenda event editing and managing module M301 for editing and managing agenda events at the network side module M300 and a communication module M302 for synchronizing agenda information between the server M200 and the network side.

According to an embodiment, a client side module M100 can be disposed in a mobile phone. The mobile phone can be communicable to the server M200. The communication module M103 can be capable of synchronizing agenda information between the client side module M100 and the server M200.

Optionally, the synchronization may be periodically performed as set by a user, in response to a particular event in client side module M100, such as, agenda event creation, initiation, receiving, denial, cancelling or amending. The synchronization can also be performed by the user manually.

According to an embodiment, such synchronization may be uploaded to server 200 through WAP communication, CDMA1x or multi-media message. The information to be synchronized can include, but is not limited to, agenda event creation, initiation, receiving, denial, cancelling, amending, participants, content, time or location, etc. The client side module M100 can encode the information to be synchronized into data messages, and compile the information to be synchronized into data packets. The server M200 can receive the data packets, decode the data packets into data message, and store the same in server M200.

Optionally, users can access the server M200 or periodically access the server M200 through certain configuration at the client side module M100 to acquire the most updated agenda information. Optionally, when agenda information is stored in the agenda information database M201, the server M200 can communicate with the client side module M100. Through the communication module M103, agenda information is synchronized between the client side module M100 and the server M200. Optionally, the client side module 100 may be disposed in a PC, PDA or other equipment.

The communication module M103 can forward the received agenda information to the agenda information management and storage module M104 for further data processing. The agenda information management and storage module M104 can receive location and map information through the location and map information loading module M102, compute a route based on the location and map information, determine an alert time based on the stored agenda information, and determine whether to notify a delay, then send alert information to the agenda event alerting module M101.

The agenda event alerting module M101 can send the user a reminder of various forms of information, such as text, images, animation, and sound. The message can also be issued to each other to schedule the late arrival notification information. If the phone has a positioning function and an electronic map installed, location and map information loading module M102 can obtain position from the local phone as well as map information. If it cannot obtain the local location and map information, the communication module M103 can connect to the network to access location and/or map information. In addition, users can also manually input the location information or use the location information and map information obtained by the agenda information management and storage module M104 to compute a route.

The network side module M300 can communication with the server M200 through network. It can be a computer, PDA, mobile phone, or other networked terminal device. The agenda event editing and managing module M301 and communication modules M302 can be installed on the network side module M300. The agenda event editing and managing module M301 can create and manage agenda. Optionally, in accordance with an embodiment, the network side module M300 can be a web interface, via which users access to specific web pages to create and manage agenda. The operations on web pages can facilitate the editing and management of the agenda.

According to this embodiment, users may log in on the network side module M300 and perform management. After the user logs in, the network side module M300 can automatically retrieve data reports from the server M200, update web pages, and add appropriate event directory according to synchronized information.

Users can create, edit and manage agenda through the agenda event editing and managing module M301 of the network side module M300. The agenda event editing and managing module M301 can send agenda information through the communication module M302 to the communication module M202 of the server M200, causing agenda information to be stored in agenda information database M201.

Optionally, when the agenda event editing and management module M301 sends agenda information through the communication module M302 to the communication module M202 of server M200, communication module M202 can send updated agenda information to the client module M100, by the client module communication module M103 to receive, identify and forward to the agenda information management and storage module M104. The agenda information management and storage module M104 can create new agenda information or modify the agenda information through synchronization.

Optional, when the agenda event editing and management module M301 sends agenda information through the communication module M302 to the communication module M202 of server M200, communication module M202 can send updated agenda information to all agenda information related participants' client side module M100. The client module communication modules M103 of various participants, respectively, receive, identify, and forward information to agenda information management and storage modules M104 of all participants. The agenda information management and storage module M104 of various participants can create new agenda information or modify and synchronize agenda information.

Optionally, the communication module M202 can send updated the agenda information to the client side module M100 of participants through short messages or multimedia MMS which can also be sent in e-mail form.

In an embodiment, an agenda management method can include the following steps: promoters to create a new agenda details; set up privacy attributes for the new agenda; recipient to view the agenda details, see the list of attendees in accordance with the privacy attributes. The privacy attributes can include “open to the recipient” and “open to all.” “Open to recipient” makes the agenda open to agenda participants; “open to all” allows anyone to see the agenda details.

This embodiment provides agenda management that allows new agenda creation or editing agenda via the web, agenda updates in the form of documents or information distributed to participants, participants via the web, and downloading and/or forwarding of the agenda.

This embodiment of the agenda management also provides methods that allow access to the venue and time and calculation of the corresponding agenda reminder time.

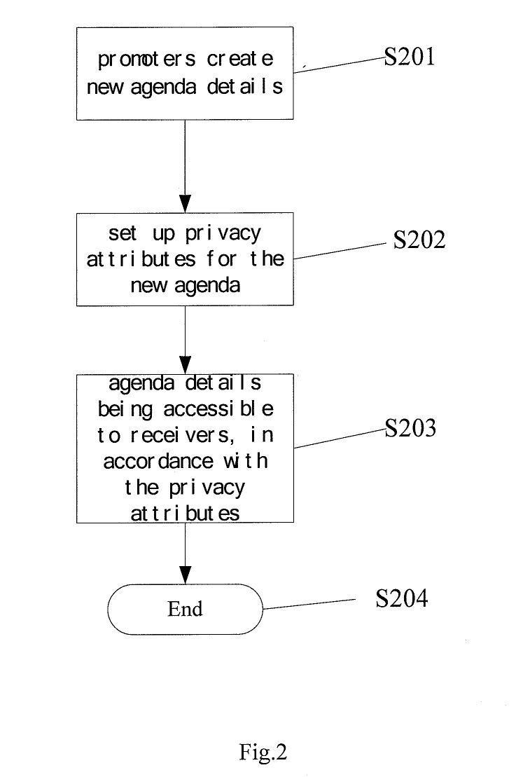

FIG. 2 shows a process of automatically configuring the property of an agenda event in accordance with one embodiment. At S201, the promoters create new agenda details. The details of the new agenda may for example include subject, location, time, participants and details. At S202: privacy attributes for the new agenda are set up. Privacy attributes may for example include “open to the recipient only” or “open to all.” “Open to the recipients only” allows agenda participants only to see the agenda details; “open to all” allows anyone to see all details of this agenda on the Internet. At S203, the receiver accesses the agenda details and sees the list of attendees, in accordance with the privacy attributes. At S204, the process ends. As shown in FIG. 2, allowing setting private property for the agenda not only make search easier but also solve conflicts among auto-sharing, privacy protection, agenda management, and cost savings for users.

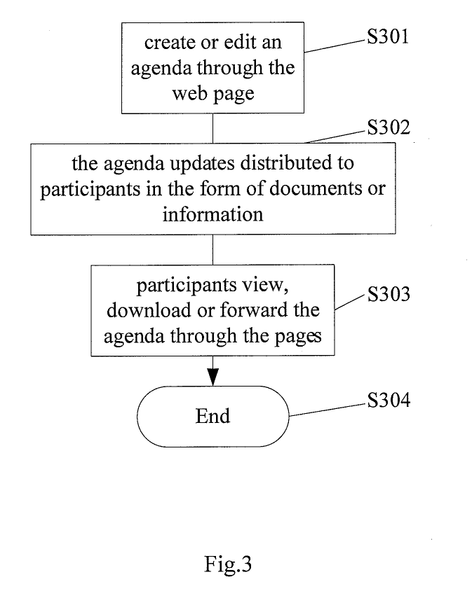

FIG. 3 shows a process of depicting a website (web, wap, etc.) to create and manage the agenda according to another embodiment. At S301, an agenda is created or edited through the web page. At S302, the agenda updates in the form of documents or information are distributed to participants. At S303, the participants view, download or forward the agenda through the pages. At S304, this process ends. As shown in FIG. 3, agendas are created, edited, sent and shared through the network, making it more convenient and economic.

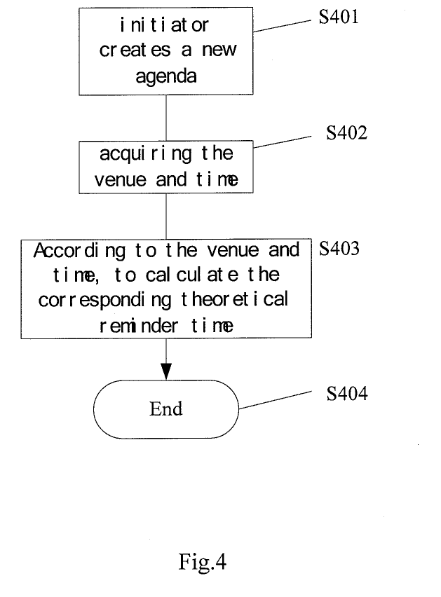

FIG. 4 shows a process of calculating an estimated reminder schedule according to another embodiment of the present invention. At S401, the initiator creates a new agenda. At S402, the venue and time are acquired. AT S403, the corresponding theoretical reminder time is calculated according to the venue and time. Participants can pre-set their common means of transport, for example, bus, car, etc. For example, according to the agenda for the Event Location: Dongcheng District, Beijing Peace East Street on the 11th hospital building, network Qin world Technology Co., Ltd.; time at: Monday (Dec. 6, 2010) in the morning 9:00. Based on distance and destination, transport and traffic conditions, if it is estimated theoretically to take up to three hours, the theoretical reminder time is then set to 6:00. If the access to information fails, the theoretical reminder time will be set as a default value, such as 1 hour or 2 hours before the agenda event. At S404, this process ends. As shown in FIG. 4, intelligent computation of reminder time, according to the subject, time and place, helps to improve the practicality of reminding function.

According to another embodiment, a method of scheduling can include the following steps: monitoring the local time (until the time taken to reach the expected reminder time) and the user's current location information; if access to location information fails, immediately starts reminding; obtain location information, based on the user's current location, plan a route to the venue; obtain an average speed of the traffic on the route in the event period; calculate the distance of time consumption; calculate the agenda actual reminder time; immediately starts reminder time when local time is reached or has passed the practical reminding time.

The method according to this embodiment can optionally include: sending reminders over a period of time to detect a user's displacement; according to the displacement of the user to determine whether it had started; if the user has not yet set off, then starts reminder.

The method according to this embodiment can optionally include further: if the user has already left, access to the user's current location; if the user has not yet arrived at the destination, based on the user's route, plan a road map to achieve the venue; obtain the remaining mileage, the route and average traffic speed in the event period; compute the time consumption of the remaining distance; calculate the estimated time of arrival; and if it is expected to reach at a time later than the agenda event starting time, then issue a notice of being late, inform the participants or promoters about being late and/or estimated arrival time.

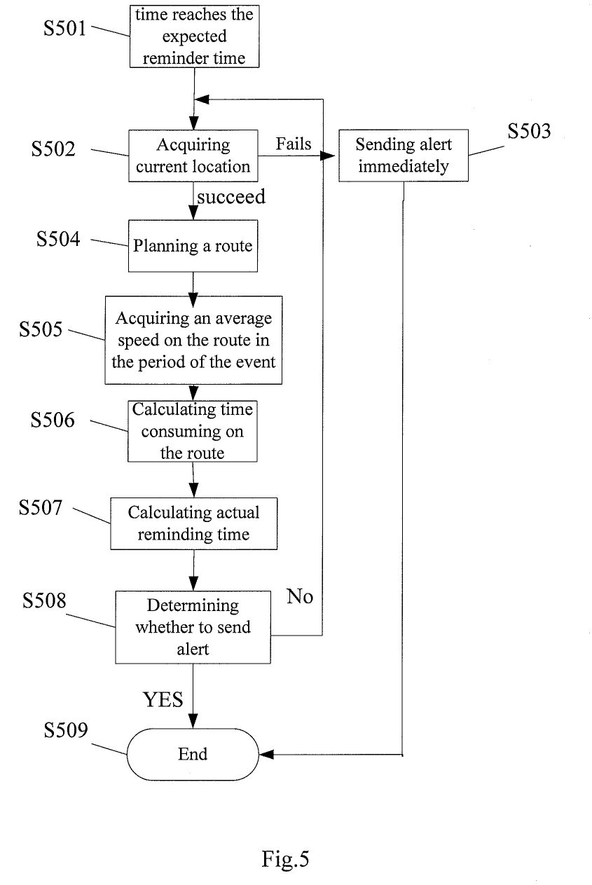

According to another embodiment, the calculation of the actual reminding time and issuance of a notice are described in FIG. 5. At S501: monitor the local time, until the time reaches the expected reminder time. The reminder time is expected to be the system time, can be automatically set according to the agenda time, or can be manually set reminder time by the user. It is expected to usually set reminder time much in advance based on the estimated time consumed. At S502: get the user's current location. At S503: if access to location information fails, immediately start reminder. The process proceeds to S509 and ends. If the location information is acquired, the process proceeds to S504: plan a route to the venue according to the user's current location. At S505: get the total mileage of the route and the average speed on the route in the time period of the event. A sample route can be: Beijing East Second Ring Road to the East Third Ring; Distance: 15 km; Time: Friday 18:30; the average speed of 30 km/h. At S506: calculate the distance of time consumption. The journey time consumption=total mileage/average speed. A sample journey time can be: 15/30=half-hour consumption. At S507: calculate the actual reminder time. For example, the actual reminder time=start time−travel time consumption. If the activities start at 18:30, journey time consumption is minutes, the actual reminder time would be 18:00. Preferably, an advance notice is set in order to prevent being late. It can also set the amount of time, such as the amount in advance for 10 minutes, the reminder time is 17:50. At S508: determine whether to start reminder. If the local time is reached or has passed the practical reminder time, immediately start the reminder and proceed to S509; if the local time not yet reached the actual reminder time, returns to S502. At S509: the process ends. As shown in FIG. 5, agenda management according to the activities, time and place, intelligent computing reminder time helps to enhance the practicality of reminder function.

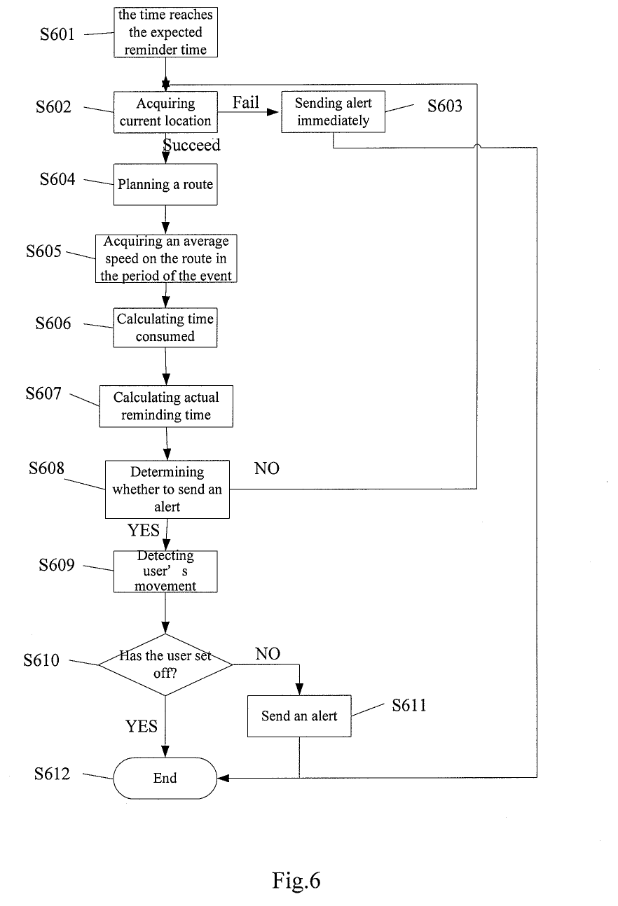

According to another embodiment, the calculation of the actual reminder time and issuance a reminder is described in FIG. 6. The process shown in FIG. 6 bases on the process of FIG. 5 and further includes multiple reminding At S601: monitor local time, until the time reaches the expected reminder time. The reminder time is expected to be the system time; it can also be automatically set according to the agenda time being expected to remind the user, or can be manually set to remind the user. It is expected to usually set reminder time much in advance based on the estimated time consumed. At S602: get the user's current location. At S603: if location information fails, immediately start to remind, then the process proceeds to S612 and ends. If the location information is acquired, proceed to S604: plan a route to the venue according to the user's current location. At S605: get the total mileage of the route and an average speed in the time period of the event on the route. For example, a place of routes: Beijing East Second Ring Road to the East Third Ring; Distance: 15 km; Time: Friday 18:30; The average speed is 30 km/h. At S606: calculate the time consumption. The journey time consumption=total mileage/average speed. For example, the journey time=15/30=half-hour consumption. At S607: calculate the actual agenda reminder time. For example, the actual reminder time=start time−travel time consumption. For example, the activities start at 18:30, journey time consumption for 30 minutes, the actual reminder time is 18:00. Preferably, using advanced notice in order to prevent being late, it can also set the amount of time, such as the amount in advance for 10 minutes, the reminder time is 17:50. At S608: determine whether to issue a departure reminder. If the local time reaches or has passed the practical reminder time, immediately start issuing reminder, and then proceed to S609. If the local time not yet reached the actual reminder time, return to S602. At S609: after sending out reminders over a period of time to detect a user's displacement, the user can set the time period. At S610: get the location of the user to determine whether the user had set off. If the user has left, proceed to S612. At S611: If the user has not yet set off, again issue a departure reminder. At S612: the process ends. As shown in FIG. 6, the process uses time and place, intelligent computing reminder time, and by acquiring location of users, to determine whether re-issued reminder, whereby improving the practicality of reminder function.

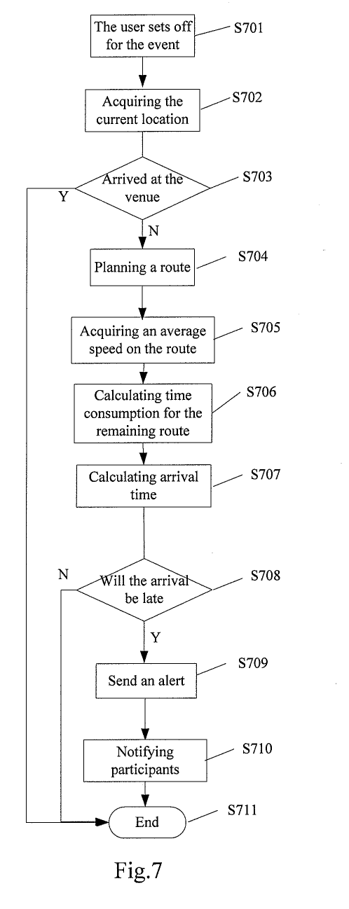

According to another embodiment, a process of monitoring distance to the venue and the issuing of late notice is described in FIG. 7. At S701: the user sets off to the destinations. At S702: get the user's current location. At S703: if the user has reached the destination, then process proceeds to S711 and ends. At S704: if the user has not reached their destinations, plan a route to the venue, according to the user's current location. At S705: acquire the average speed on the route in the event period, as well as the remaining total mileage. Preferably, use the integrated real-time traffic information to predict the average speed since the departure, and use the selected route to calculate average speed. At S706: calculate the time consumption for the remaining distance, travel time consumption=total mileage/average speed. At S707: calculate the estimated time of arrival. At S708: If you expected to reach earlier than or equal to the event start time, proceed to S711. At S709: If you anticipate a time later than the commencement of the event, then issue a reminder. At S710: notify participants or promoters of possibly being late and/or estimated a time of arrival. At S711: the process ends. The process as shown in FIG. 7 can include monitoring the user's location, intelligent determining whether it would be late, and automatically notifying participants or promoters. Thus, it helps to enhance the interaction between the two sides, also helps to avoid the danger of text messaging or calling while driving.

Although the disclosure in this document refers to embodiments, those skills in the art should understand that the above embodiments are only illustrative, but not limitative. Some features of the above embodiments can also be used in other embodiments. It is intended that the disclosure covers all modifications and alternatives defined by the scope of the claims.

We claim:

1. A method for managing agenda events, comprising:
creating an agenda event and details of the agenda event by an initiator;
configuring privacy attributes for the agenda event; and
viewing by a receiver the details of the agenda event and a list of all participants of the event based on the privacy attributes.

2. The method of claim 1, wherein the privacy attributes are configured to allow accessibility for receivers only or accessibility for everybody; wherein accessibility for receivers only allows the details of the agenda event to be viewable among receivers who accept the agenda event; and wherein accessibility for everybody allows the details of the agenda event to be viewable to everyone on the Internet.

3. The method of claim 1 or 2, further comprising:
creating or editing the agenda event on a web page; and
sending the agenda event or updates of the agenda event as a file or a message to participants; wherein the participants can view, download and/or forward the agenda event.

4. The method of claim 1 or 2, further comprising:
acquiring location and schedule information of the agenda event; and
computing corresponding reminding time according to the location and schedule information of the agenda event.

5. A method for managing agenda events, comprising:
monitoring and controlling a local time, until a predetermined reminding time;
acquiring a current location information of a user and, if it fails, sending an alert immediately, if it succeeds, planning a route to a location of an event according to the current location information;
acquiring a length of the route and acquiring an average vehicle speed on the route during a period at the beginning of the event;
computing time consumed;
computing an actual alert time; and
sending the alert if the local time is equal to or later than the actual alert time.

6. The method of claim 5, further comprising:
detecting the current location of the user periodically after sending the alert; and
determining whether the user is on the way to the event, according to the current location of the user, and if not, sending the alert again.

7. The method of claim 6, further comprising:
detecting the current location of the user, if the user has set off;
planning the route to the location of the event according to the current location of the user, if the user has not arrived;
acquiring a remaining length of the route and an average vehicle speed on the route during a period at the beginning of the event;
computing a remaining time for the route; and
computing an arrival time and, if the arrival time is later then the start time of the event, informing participants or initiator of a delay or an estimated arrival time.

8. A system for managing agenda events, comprising:
a client side module;
a server; and
a network side module;
wherein the client side module includes: an agenda event alerting module for sending alerts for agenda events, a location and map information loading module for loading location and map information, a communication module for synchronizing agenda information between the client side module and the network side module, an agenda information management and storage module for managing and storing agenda information and sending information corresponding to the alert to the agenda event alerting module,
wherein the server includes: an agenda information database for storing and maintaining and a communication module for synchronizing agenda information between the client side module and the network side,
wherein the network side module includes: an agenda event editing and managing module for editing and managing agenda events and a communication module for synchronizing agenda information between the server and the network side module.

9. The system of claim 8, wherein the agenda information management and storage module is configured to acquire location and map information from the location and map information loading module, compute a route based on the location and map information, and determine an alert time according to the stored agenda event information or determine whether to send a notice for late arrival.

10. The system of claim 8 or 9, wherein the network side module includes a web page via which a user creates and manages the agenda events.
